(19) United States
(12) Patent Application Publication
(10) Pub. No.: US 2026/0177797 A1
(43) Pub. Date: Jun. 25, 2026

(54) MICROSCOPE THAT INCLUDES A PATTERN PROJECTION COMPONENT

(71) Applicant: VIAVI Solutions Inc., Chandler, AZ (US)

(72) Inventors: Kevin CASSADY, Monroe, WA (US); Jay Gregory BRACE, Lynnwood, WA (US)

(21) Appl. No.: 18/999,169

(22) Filed: Dec. 23, 2024

(51) Int. Cl. G02B 21/00

(52) U.S. Cl. CPC G02B 21/0032; G02B 21/0016

(57) ABSTRACT

A microscope includes a light source positioned at a light source plane of the microscope, a pattern projection component positioned at a light stop plane of the microscope, and an optical sensor positioned at an image plane of the microscope. The light source is configured to transmit light to an object plane of the microscope via the pattern projection component. The pattern projection component is configured to, when the light interacts with the pattern projection component, cause the light to carry a pattern. The pattern, when the light transmits from the pattern projection component to an object positioned at the object plane, is projected on a region of the object.

### BACKGROUND

A microscope may include an instrument used to see objects that are too small to be seen by the naked eye. Microscopy may include investigating small objects and structures using a microscope. A microscope may be used to view and inspect an end face of an optical fiber.

### SUMMARY

In some implementations, a microscope comprises: a light source positioned at a light source plane of the microscope; a pattern projection component positioned at a light stop plane of the microscope; and an optical sensor positioned at an image plane of the microscope, wherein: the light source is configured to transmit light to an object plane of the microscope via the pattern projection component, and the pattern projection component is configured to, when the light interacts with the pattern projection component, cause the light to carry a pattern, wherein the pattern, when the light transmits from the pattern projection component to an object positioned at the object plane, is projected on a region of the object.

In some implementations, a microscope comprises: a light source; and a pattern projection component positioned along a light path of light transmitted from the light source to an object plane of the microscope, wherein: the pattern projection component is configured to cause the light to carry a pattern, wherein the pattern, when the light transmits from the pattern projection component to an object positioned at the object plane, is projected on a region of the object.

In some implementations, a pattern projection component for a microscope comprises: one or more pattern elements that define a pattern, wherein the one or more pattern elements are configured to cause light, that is transmitted from a light source of the microscope and to the pattern projection component, to carry the pattern when transmitted from the pattern projection component.

### BRIEF DESCRIPTION OF THE DRAWINGS

FIG. 1 is a diagram of one or more example implementations described herein that are associated with a microscope that includes a pattern projection component.

FIGS. 2A-2C are diagrams of one or more example implementations described herein that are associated with a microscope that includes a pattern projection component.

FIGS. 3A-3D are diagrams of an example process described herein.

FIGS. 4A-4B are diagrams of one or more example implementations described herein that are associated with a microscope that includes a pattern projection component.

FIG. 5 is a diagram of example components of a device associated with a microscope that includes a pattern projection component.

### DETAILED DESCRIPTION

The following detailed description of example implementations refers to the accompanying drawings. The same reference numbers in different drawings may identify the same or similar elements.

A microscope can be used to inspect a region of an object. For example, when the microscope is an optical fiber inspection microscope, the microscope can be used to inspect an end face of an optical fiber (e.g., after manufacture of the optical fiber, prior to connecting the optical fiber to network equipment, along with other examples). In some cases, in order for the region of the object to be inspected, the object is positioned at an object plane of the microscope, and light (e.g., that is provided by a light source of the microscope) is transmitted to the object plane to illuminate the region of the object. Reflected light from the region of the object then transmits to an optical sensor of the microscope, which allows the optical sensor to capture an image of the region of the object. This image then can be analyzed to determine a condition of a surface of the region of the object. For example, when the image depicts an end face of an optical fiber, the image may be analyzed to identify dirt particles, dust particles, scratches, and/or other surface irregularities on the end face of the optical fiber.

However, because the two-dimensional (2D) image lacks any indication of three-dimensional (3D) information, a 3D geometry of the region and a 3D geometry of the surface irregularities cannot be determined. For example, when the image depicts the end face of the optical fiber, 3D geometrical dimensions of the end face and 3D geometrical dimensions of the dirt particles, the dust particles, the scratches, and/or the other surface irregularities on the end face of the optical fiber cannot be determined. This can result in significant geometric “depth” issues being unidentified and unaddressed (e.g., because such issues cannot be identified by analyzing the 2D image), which, when the image depicts the end face of the optical fiber, can impact a performance of the optical fiber (e.g., because the optical fiber is more likely to experience insertion loss, return loss, back reflection, and/or mode field distortion, along with other examples).

Some implementations described herein include a microscope. The microscope includes a light source and a pattern projection component. The pattern projection component is positioned at a point along a light path of light that is transmitted from the light source to an object plane of the microscope. For example, the pattern projection component may be positioned at a light stop plane of the microscope (e.g., the pattern projection component is disposed on or within an aperture stop of the microscope).

The pattern projection component is configured to cause the light, that is transmitted from the light source to the pattern projection component, to carry a pattern (e.g., cause variations across a spatial distribution of the light in terms of brightness, intensity, shape, or other characteristics). That is, when the light interacts with the pattern projection component, the pattern projection component causes the light to carry the pattern (e.g., when transmitted from the pattern projection component). In some implementations, the light transmits from the pattern projection component to an object (e.g., when the object is positioned at the object plane), and the pattern is projected on a region of the object. In this way, a 2D pattern is projected on a 3D region of the object.

In some implementations, a portion of the light (e.g., a reflected portion of the light that carries the pattern) returns to the microscope, and transmits to an optical sensor of the microscope. Due to one or more variations in a 3D geometry of the region of the object, the portion of the light carries an altered version of the pattern. The optical sensor captures an image of the region of the object (e.g., by converting the portion of the light into the image), and therefore the image depicts the altered version of the pattern.

In this way, the altered version of the pattern indicates 3D information related to the region of the object (e.g., where pattern alterations are associated with surface irregularities associated with the region of the object). Accordingly, in some implementations, one or more processors of the microscope determine and provide assessment information associated with the region of the object, such as by analyzing the image that depicts the altered version of the pattern. The assessment information indicates, for example, a 3D geometry of the region of the object and/or a 3D geometry of one or more surface irregularities associated with the region of the object (e.g., dirt particles, dust particles, scratches, chips, fingerprints, debris, and/or other defects affecting the region of the object). Accordingly, the assessment information may indicate whether the region of the object is damaged, malformed, dirty, and/or otherwise suboptimal.

In this way, the microscope enables a technician or other user to determine a 3D geometrical condition of the region of the object. Accordingly, a geometric depth issue can be identified and addressed, which would not otherwise be practically possible using a microscope that does not include a pattern projection component. When the region of the object is an end face of an optical fiber, a performance of the optical fiber can be improved (e.g., by identifying and addressing the geometric depth issues to reduce insertion loss, return loss, back reflection, and/or mode field distortion, along with other examples). Further, computing resources (e.g., processing resources, memory resources, communication resources, and/or power resources, among other examples) of other devices that would be otherwise be used to identify, address, and/or compensate for a poor performance of the optical fiber are conserved.

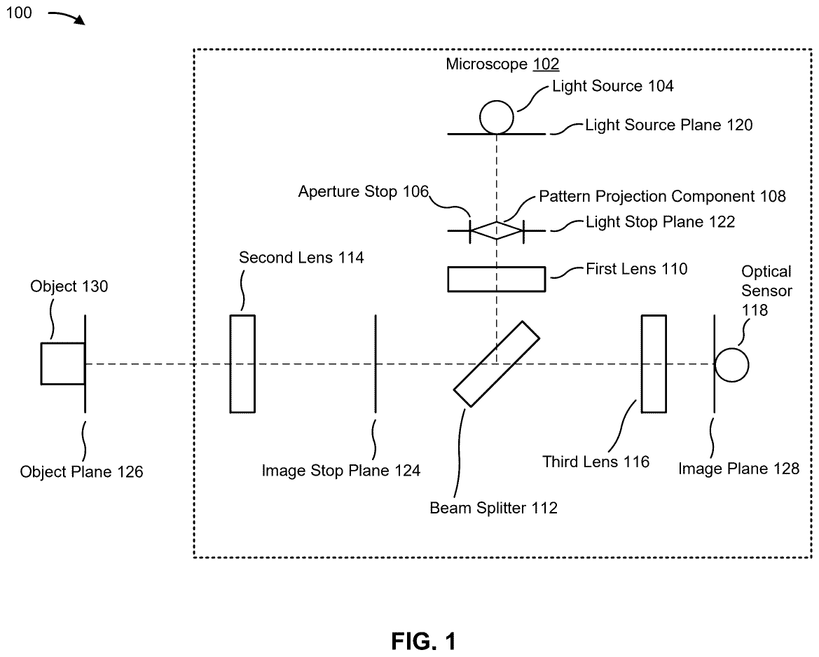

FIG. 1 is a diagram of one or more example implementations 100 described herein that are associated with a microscope that includes a pattern projection component. As shown in FIG. 1, the example implementation(s) 100 includes a microscope 102, which may include (e.g., housed within the microscope 102) one or more optical components, such as a light source 104, an aperture stop 106, a pattern projection component 108, a first lens 110, a beam splitter 112, a second lens 114, a third lens 116, and/or an optical sensor 118. As further shown in FIG. 1, the microscope 102 may include (or may be associated with) a light source plane 120, a light stop plane 122, an image stop plane 124, an object plane 126, and/or an image plane 128 (e.g., that are associated with the one or more optical components of the microscope 102).

The microscope 102 may be configured to optically inspect an object 130. For example, the microscope 102 may be configured to capture and/or analyze an image of a region of the object 130, such as when the object (e.g., the region of the object 130) is positioned at the object plane 126.

The light source 104 may be positioned at the light source plane 120. The light source 104 may be configured to transmit light to the object plane 126 (e.g., to illuminate the region of the object 130 when the object 130 is positioned at the object plane 126). The light source 104 may be configured to transmit the light to the object plane 126 via one or more other optical components of the microscope 102, such as via the aperture stop 106, the pattern projection component 108, the first lens 110, the beam splitter 112, and/or the second lens 114. The light source 104 may include a light emitting diode (LED), or another type of light source. In some implementations, the light source 104 may enable Kohler illumination of the region of the object 130.

The aperture stop 106 may be positioned at the light stop plane 122. The aperture stop 106 may be configured to control an angular distribution of the light that is transmitted from the light source 104 to the aperture stop 106. For example, the aperture stop 106 may include an aperture (e.g., a diaphragm, an iris, or another type of aperture), which may limit a size of a light cone of the light as the light passes through the aperture.

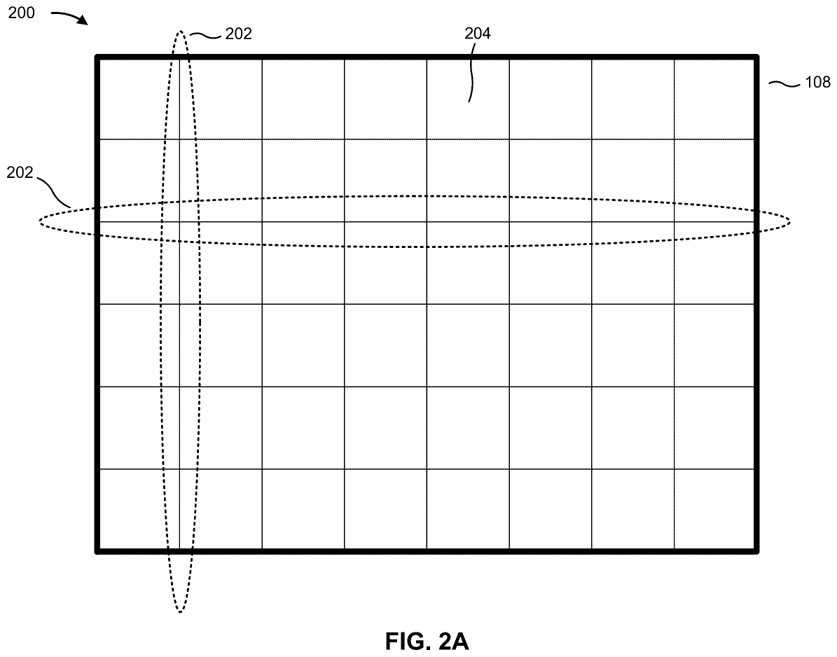

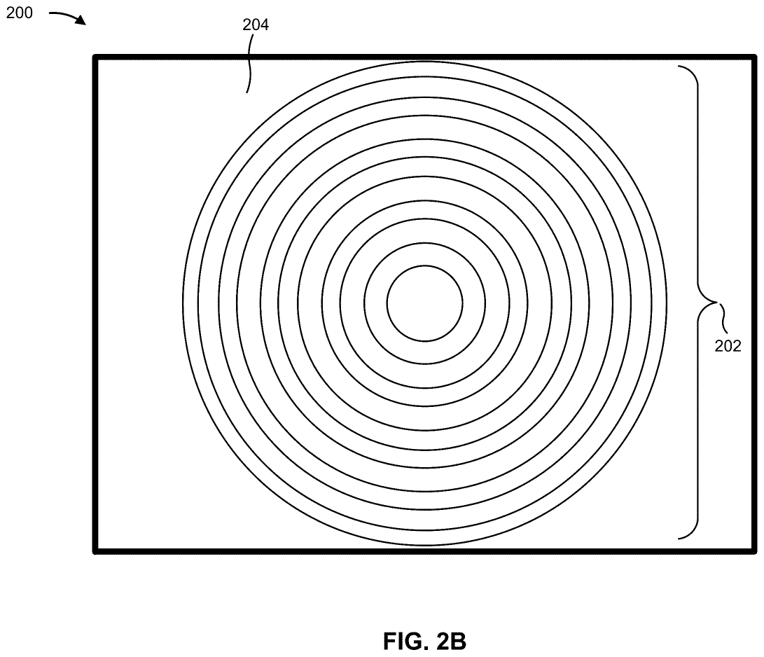

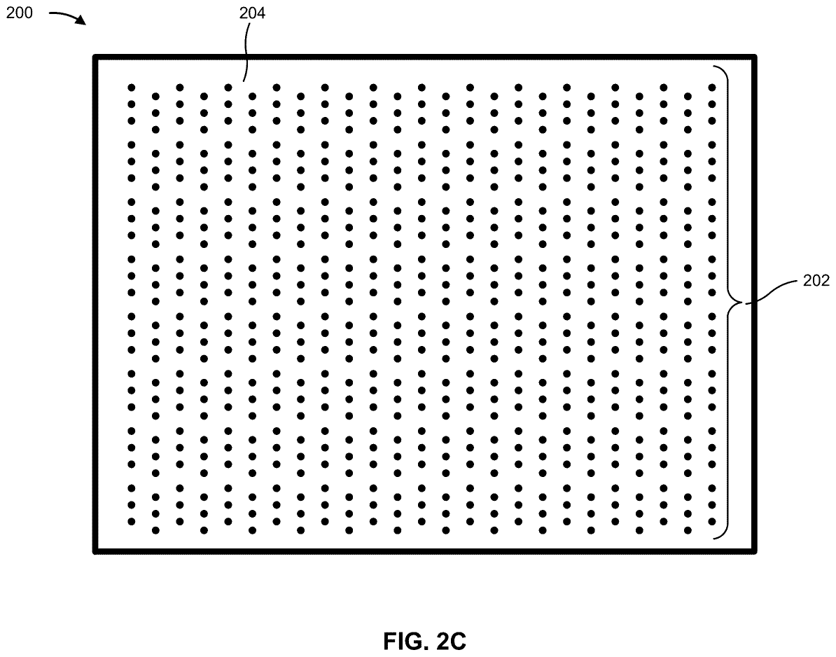

The pattern projection component 108 may be positioned along a light path of the light transmitted from the light source 104 to the object plane 126. The pattern projection component 108 may be configured to cause the light, that is transmitted from the light source 104 to the pattern projection component 108, to carry a pattern (e.g., cause variations across a spatial distribution of the light in terms of brightness, intensity, shape, or other characteristics). That is, when the light interacts with the pattern projection component 108, the pattern projection component 108 may cause the light to carry the pattern (e.g., when transmitted from the pattern projection component 108). In some implementations, the pattern projection component 108 may include one or more pattern elements that define the pattern, as further described herein in relation to FIGS. 2A-2C. Additionally, as further described herein, when the light transmits from the pattern projection component 108 to the object 130 (e.g., when the object is positioned at the object plane 126), the pattern may be projected on a region of the object 130.

As shown in FIG. 1, the pattern projection component 108 may be positioned at the light stop plane 122 (e.g., regardless of whether the aperture stop 106 is included in the microscope 102). Because the light stop plane 122 is a conjugate of the object plane 126, positioning the pattern projection component 108 at the light stop plane 122 facilitates an optimal projection (e.g., in terms of focus or another characteristic) of the pattern on the region of the object 130 (e.g. at the object plane 126). In some implementations, the pattern projection component 108 may be disposed on or within the aperture stop 106 (e.g., at the light stop plane 122). For example, the pattern projection component 108 may be disposed within the aperture of the aperture stop 106.

In some implementations, the pattern projection component 108 may be positioned at another point (e.g., within the microscope 102) along the light path of the light transmitted from the light source 104 to the object plane 126, such as at a point that is aligned with a plane that is a conjugate of the object plane 126. For example, the pattern projection component 108 may be disposed on or within the first lens 110, the beam splitter 112, and/or the second lens 114.

In some implementations, the pattern projection component 108 may be configured to removably connect to the microscope 102 (e.g., removably connect to one or more components of the microscope 102). That is, the pattern projection component 108 may not be permanently fixed to the microscope 102, and may be removed or attached to the microscope 102 at any time (e.g., without damaging the microscope 102). For example, when the microscope 102 includes the aperture stop 106, the pattern projection component 108 may be removably connected to the aperture stop 106. In this way, the pattern projection component 108 may be removed from the microscope 102 to allow the microscope 102 to illuminate the object 130 without projecting the pattern on the region of the object 130, or to allow a different pattern projection component 108 to be included in the microscope 102, which allows the microscope 102 to project another pattern on the region of the object 130.

The first lens 110 may be positioned along the light path of the light transmitted from the light source 104 to the object plane 126. For example, as shown in FIG. 1, the first lens 110 may be positioned between the light stop plane 122 and the beam splitter 112. The first lens 110 may be configured receive the light that is transmitted from the pattern projection component 108 (and/or the aperture stop 106) and to direct and/or focus the light onward to the beam splitter 112. In this way, the first lens 110 facilitates alignment of the light for other optical components along the light path, such as for the beam splitter 112. The first lens 110 may be, for example, a condensing lens, or a similar type of lens, and may comprise a glass, a polymer, or a similar type of material.

The beam splitter 112 may be positioned along the light path of the light transmitted from the light source 104 to the object plane 126. For example, as shown in FIG. 1, the beam splitter 112 may be positioned between the light stop plane 122 and the image stop plane 124. The beam splitter 112 may be configured to receive the light that is transmitted from the pattern projection component 108 (and/or the aperture stop 106), such as via the first lens 110, and to direct and/or focus the light onward to the object 130 (e.g., via the second lens 114), such as by reflecting the light. In this way, the beam splitter 112 facilitates illumination of the region of the object 130 and projection of the pattern on the region of the object 130.

The second lens 114 may be positioned along the light path of the light transmitted from the light source 104 to the object plane 126. For example, as shown in FIG. 1, the second lens 114 may be positioned between the image stop plane 124 and the object plane 126 (while being positioned within the microscope 102). The second lens 114 may be configured to receive the light that is transmitted from the pattern projection component 108 (and/or the aperture stop 106), such as via the first lens 110 and the beam splitter 112, and to direct and/or focus the light onward to the object 130. In this way, the second lens 114 facilitates alignment of the light for illumination of the region of the object 130 and projection of the pattern on the region of the object 130.

In this way, the light that carries the pattern may transmit from the pattern projection component 108 to the object plane 126 (e.g., via the first lens 110, the beam splitter 112, and/or the second lens 114). When the object 130 is positioned at the object plane 126, the light may impinge on the region of the object 130, and therefore the pattern (e.g., that is carried by the light) may be projected onto the region of the object. A portion of the light (e.g., a reflected portion of the light that carries the pattern) may therefore return to the microscope 102, and may transmit to the optical sensor 118, as further described herein. Due to one or more variations in a 3D geometry of the region of the object 130, the reflected portion of the light may carry an altered version of the pattern. The reflected portion of the light that carries the altered version of the pattern is hereinafter referred to as the “image light.”

Accordingly, the second lens 114 may be additionally positioned along a light path of the image light transmitted from the object 130 to the optical sensor 118. For example, as shown in FIG. 1, the second lens 114 may be positioned between the image stop plane 124 and the object plane 126 (while being positioned within the microscope 102). The second lens 114 therefore may also be configured to receive the image light that is transmitted from the object 130 and to direct and/or magnify the image light onward to the optical sensor 118 (e.g., via the beam splitter 112 and/or the third lens 116). In this way, the second lens 114 facilitates imaging of the region of the object 130 (e.g., by the optical sensor 118). Accordingly, the second lens 114 may be, for example, an objective lens, or a similar type of lens, and may comprise a glass, a polymer, or a similar type of material.

The beam splitter 112 may additionally be positioned along the light path of the image light transmitted from the object 130 to the optical sensor 118. For example, as shown in FIG. 1, the beam splitter 112 may be positioned between the image stop plane 124 and the image plane 128. The beam splitter 112 therefore may also be configured to receive the image light that is transmitted from the object 130, such as via the second lens 114, and to direct and/or focus the image light onward to the optical sensor 118 (e.g., via the third lens 116), such as by transmitting the image light. In this way, the beam splitter 112 facilitates imaging of the region of the object 130 (e.g., by the optical sensor 118). Accordingly, the beam splitter 112 may comprise one or more partially reflective materials or coatings that allow the beam splitter 112 to both reflect light (e.g., toward the object plane 126) and transmit light (e.g., to the optical sensor 118).

The third lens 116 may be positioned along the light path of the image light transmitted from the object 130 to the optical sensor 118. For example, as shown in FIG. 1, the third lens 116 may be positioned between the beam splitter 112 and the image plane 128. The third lens 116 therefore may be configured to receive the image light that is transmitted from the object 130, such as via the second lens 114 and/or the beam splitter 112, and to direct and/or magnify the image light onward to the optical sensor 118. In this way, the third lens 116 facilitates imaging of the region of the object 130 (e.g., by the optical sensor 118). Accordingly, the third lens 116 may be, for example, a tube lens, or a similar type of lens, and may comprise a glass, a polymer, or a similar type of material.

The optical sensor 118 may be positioned at the image plane 128. The optical sensor 118 may be configured to capture an image (or multiple images, such as a continuous stream of images associated with video) of the region of the object 130 (e.g., when the pattern is projected onto the region of the object, as described elsewhere herein). Accordingly, the optical sensor 118 may be configured to receive the image light that is transmitted from the object 130, such as via the second lens 114, the beam splitter 112, and/or the third lens 116, and to convert the image light into an image (or multiple images). In this way, the optical sensor 118 may be configured to capture an image of the region of the object 130 that depicts the altered version of the pattern (e.g., due to the one or more variations in a 3D geometry of the region of the object 130). In some implementations, the optical sensor 118 may include an image sensor such as a charge-coupled device (CCD) sensor, a complementary metal-oxide semiconductor (CMOS) sensor, and/or another type of image sensor.

In some implementations, the microscope 102 may be a particular type of microscope. For example, the microscope 102 may be an optical fiber inspection microscope (e.g., for inspecting end faces of optical fibers). In this way, the object 130 may be an optical fiber, and a region of the object 130 may be an end face of the optical fiber. Accordingly, the microscope 102 may include the pattern projection component 108 to cause light, that is transmitted to the object plane 126, to carry a pattern such that the pattern is projected onto the end face of the optical fiber (e.g., when the optical fiber is positioned at the object plane 126). The microscope 102 then may use the optical sensor 118 to capture an image (or multiple images) of the end face of the optical fiber with the pattern projected onto the end face of the optical fiber (e.g., by capturing image light from the end face of the optical fiber that may include an altered version of the pattern that is a result of one or more variations in a 3D geometry of the end face of the optical fiber).

As indicated above, FIG. 1 is provided as one or more examples. Other examples may differ from what is described with regard to FIG. 1. In practice, there may be additional components, fewer components, different components, or differently arranged components than those shown in FIG. 1.

FIGS. 2A-2C are diagrams of one or more example implementations 200 described herein that are associated with a microscope that includes a pattern projection component. As shown in FIGS. 2A-2C, the example implementation(s) 200 includes example configurations of the pattern projection component 108, which may include one or more pattern elements 202.

A pattern element 202, of the one or more pattern elements 202, may comprise a reflective characteristic, a diffractive characteristic, a refractive characteristic, an absorbent characteristic, and/or a transmissive characteristic, along with other examples. For example, the pattern element may comprise a material (e.g., a glass, a polymer, a metal, or another type of material) that at least one of reflects, diffracts, refracts, absorbs (e.g., at least partially absorbs), or transmits (e.g., at least partially transmits) light transmitted by the light source 104 of the microscope 102 to the pattern projection component 108. In this way, the one or more pattern elements may define a pattern that is to be carried by the light (e.g., cause variations across a spatial distribution of the light in terms of brightness, intensity, shape, or other characteristics) when the light transmits from the pattern projection component 108, such as to the object plane 126.

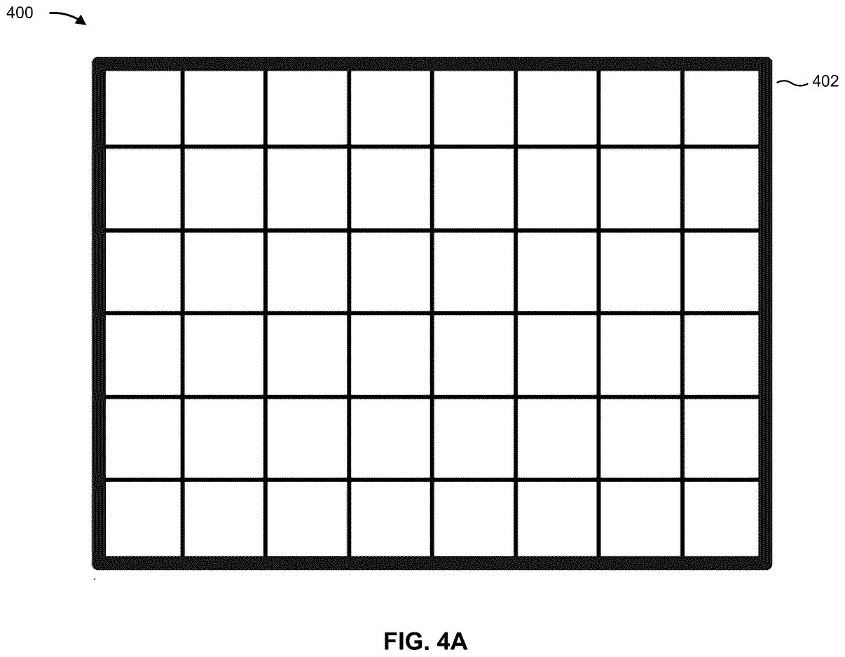

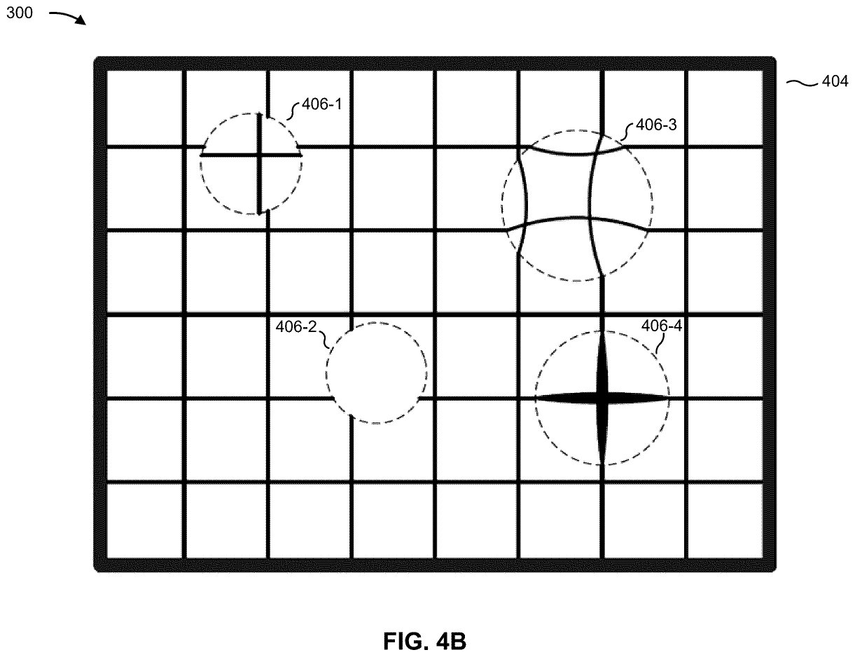

As shown in FIG. 2A, the pattern projection component 108 may include one or more pattern elements 202 that form a grid. Accordingly, the one or more pattern elements 202 may define a grid pattern and may thereby cause light to carry the grid pattern (e.g., to the object plane 126), which may cause projection of the grid pattern on a region of the object 130 (e.g., when the object 130 is positioned at the object plane 126), such as in a manner described herein in relation to FIG. 4A. As shown in FIG. 2B, the pattern projection component 108 may include one or more pattern elements 202 that form concentric rings. Accordingly, the one or more pattern elements 202 may define a concentric ring pattern and may thereby cause light to carry the concentric ring pattern (e.g., to the object plane 126), which may cause projection of the concentric ring pattern on a region of the object 130 (e.g., when the object 130 is positioned at the object plane 126). As shown in FIG. 2C, the pattern projection component 108 may include one or more pattern elements 202 that form a field of dots (or other polygonal or round shapes). Accordingly, the one or more pattern elements 202 may define a dot pattern and may thereby cause light to carry the dot pattern (e.g., to the object plane 126), which may cause projection of the dot pattern on a region of the object 130 (e.g., when the object 130 is positioned at the object plane 126).

As further shown in FIGS. 2A-2C, the one or more pattern elements 202 may be embedded in a material 204, such as to allow the one or more pattern elements 202 to have a particular position, shape, and/or orientation, among other examples, within the pattern projection component 108. The material 204 may be a transmissive material (e.g., a glass, a polymer, or a similar type of material that is at least partially transmissive to light transmitted by the light source 104 of the microscope 102).

As indicated above, FIGS. 2A-2C are provided as one or more examples. Other examples may differ from what is described with regard to FIGS. 2A-2C. In practice, there may be additional components, fewer components, different components, or differently arranged components than those shown in FIGS. 2A-2C.

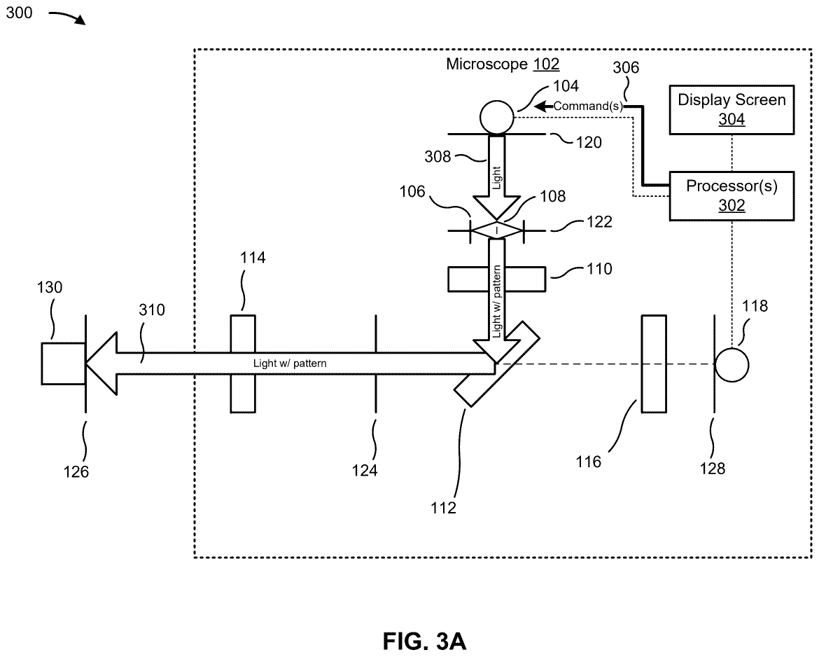

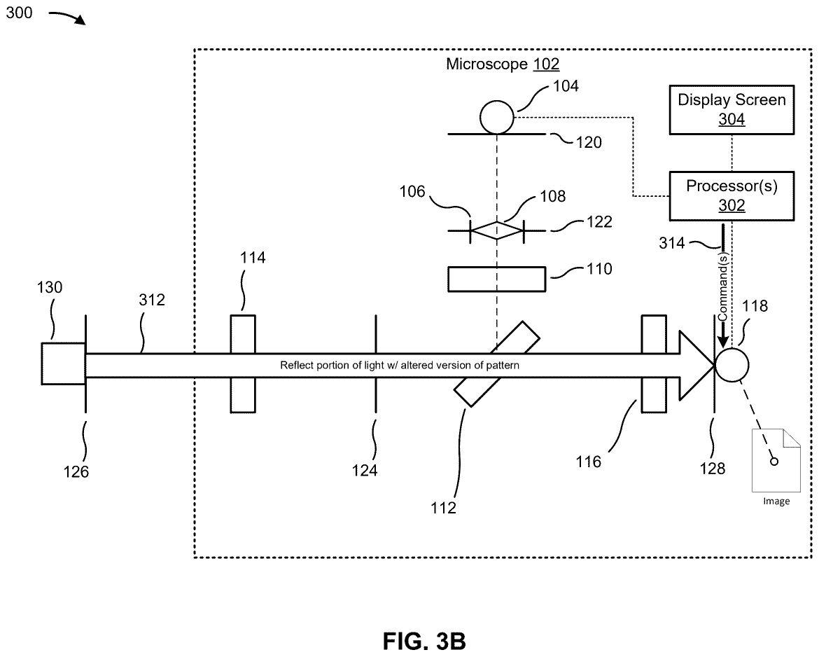

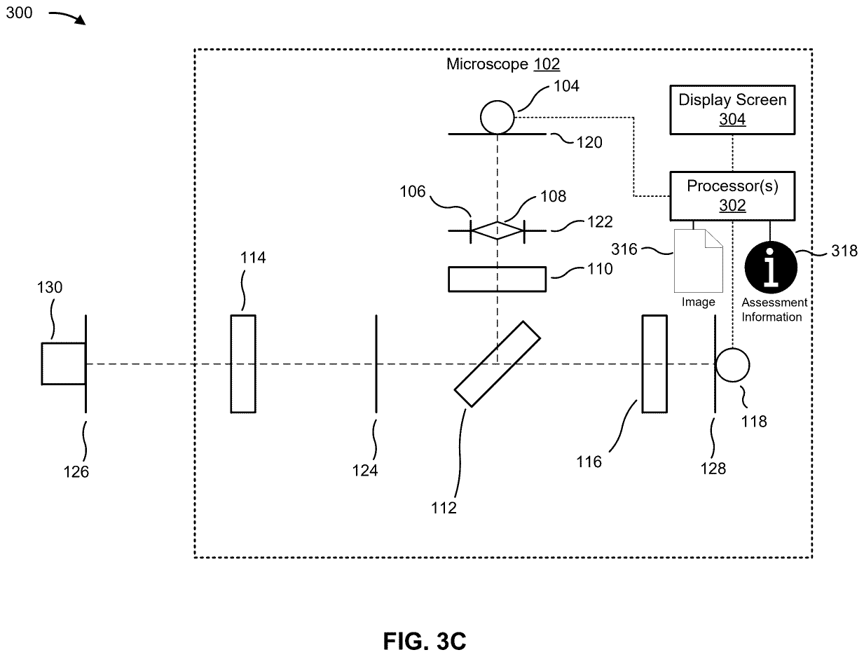

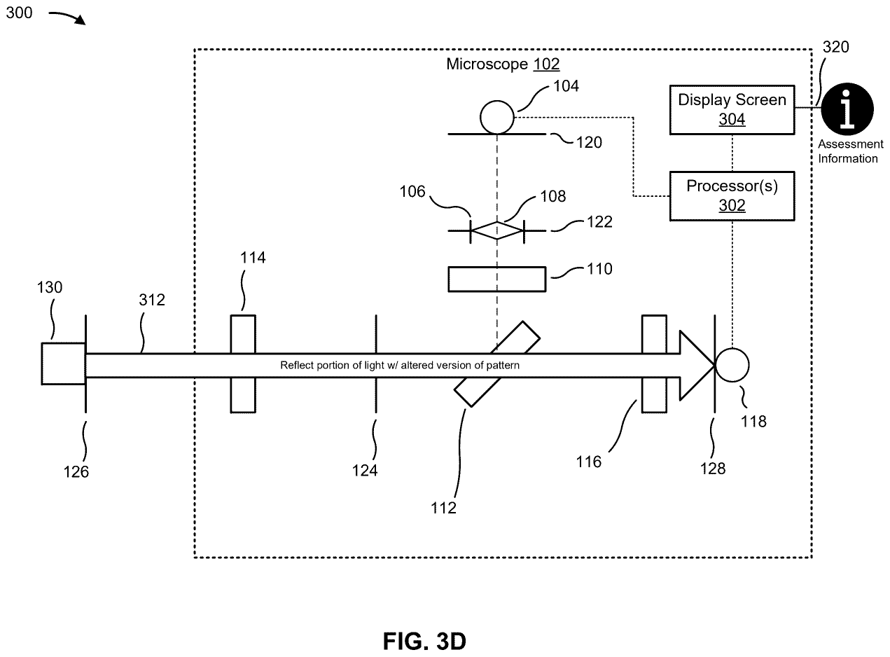

FIGS. 3A-3D are diagrams of an example process 300 described herein. As shown in FIGS. 3A-3D, the example process 300 may be associated with the microscope 102, which may include the light source 104, the aperture stop 106, the pattern projection component 108, the first lens 110, the beam splitter 112, the second lens 114, the third lens 116, the optical sensor 118, the light source plane 120, the light stop plane 122, the image stop plane 124, the object plane 126, and/or the image plane 128, as described elsewhere herein.

As further shown in FIGS. 3A-3D, the microscope 102 may also include one or more processors 302 and/or a display screen 304. The one or more processors 302 may be configured to control and/or to communicate with one or more components of the microscope 102, such as the light source 104, the optical sensor 118 and/or the display screen 304. The display screen 304 may include any type of display screen (e.g., a non-interactive display screen, an interactive display screen, or another type of display screen), or another type of device, that visually, audibly, and/or haptically presents information (e.g., to an observer). The display screen 304 may be sized and/or positioned such that an operator of the microscope 102 may observe the display screen 304 in association with using the microscope 102, as described herein.

As shown in FIG. 3A, and by reference number 306, the one or more processors 302 may cause the light source 104 to transmit light to the object plane 126. For example, the one or more processors 302 may send one or more commands to the light source 104 (e.g., via a communication connection between the one or more processors 302 and the light source 104) that cause the light source 104 to transmit light to the object plane 126.

As shown by reference number 308, the light may transmit to the pattern projection component 108 (e.g., along a light path from the light source 104 to the object plane 126), which may cause the light to carry a pattern. For example, the light may interact with the pattern projection component 108 (e.g., may interact with the one or more pattern elements 202 of the pattern projection component 108 that define the pattern), which causes the light to carry the pattern.

As shown by reference number 310, the light may transmit from the pattern projection component 108 to the object 130 (e.g., when the object 130 is positioned at the object plane 126), which causes the pattern to be projected on a region of the object 130.

As shown in FIG. 3B, and by reference number 312, a portion of the light (e.g., a reflected portion of the light that carries the pattern) may return to the microscope 102, and may transmit to the optical sensor 118. Due to one or more variations in a 3D geometry of the region of the object 130, the portion of the light may carry an altered version of the pattern.

As shown by reference number 314, the one or more processors 302 may cause the optical sensor 118 to capture an image (or images) of the region of the object 130 (e.g., when the pattern is projected on the region of the object 130). For example, the one or more processors 302 may send one or more commands to the optical sensor 118 (e.g., via a communication connection between the one or more processors 302 and the optical sensor 118) that cause the optical sensor 118 to capture the image. The optical sensor 118 may capture the image by converting the portion of the light (e.g., that carries the altered version of the pattern), as received by the optical sensor 118, into the image. Accordingly, the image may depict the altered version of the pattern (e.g., due to the one or more variations in a 3D geometry of the region of the object 130).

As shown in FIG. 3C, and by reference number 316, the one or more processors 302 may obtain the image. For example, the one or more processors 302 may send one or more requests to the optical sensor 118 (e.g., via the communication connection between the one or more processors 302 and the optical sensor 118) that cause the optical sensor 118 to send the image to the one or more processors 302 (e.g., via the communication connection).

As shown by reference number 318, the one or more processors 302 may determine assessment information associated with the region of the object 130. In some implementations, the one or more processors 302 may analyze (e.g., using a set of one or more analysis techniques, such as for determining 3D geometrical features of the region of the object 130) the image to determine the assessment information. Accordingly, the one or more processors 302 may analyze the altered version of the pattern, as depicted by the image, to determine the assessment information. The assessment information may indicate, for example, a 3D geometry of the region of the object 130 and/or a 3D geometry of one or more surface irregularities associated with the region of the object 130 (e.g., dirt particles, dust particles, scratches, chips, fingerprints, debris, and/or other defects affecting the region of the object 130). Accordingly, the assessment information may indicate whether the region of the object 130 is damaged, malformed, dirty, and/or otherwise nonoptimal.

As shown in FIG. 3D, and by reference number 320, the one or more processors 302 may provide the assessment information. For example, the one or more processors 302 may send the assessment information to the display screen 304, which may allow the display screen 304 to display at least a portion of the assessment information. As a specific example, the one or more processors 302 may send the assessment information to the display screen 304 in association with sending the image to the display screen 304. This may allow the display screen 304 to display at least a portion of the assessment information (e.g., as a text overlay and/or an image overlay) when displaying the image.

As indicated above, FIGS. 3A-3D are provided as one or more examples. Other examples may differ from what is described with regard to FIGS. 3A-3D. In practice, there may be additional components, fewer components, different components, or differently arranged components than those shown in FIG. 3A-3D.

FIGS. 4A-4B are diagrams of one or more example implementations 400 described herein that are associated with a microscope that includes a pattern projection component. FIG. 4A shows an example of a pattern 402 that is carried by light (e.g., that is transmitted from the pattern projection component 108 to the object plane 126) and projected on a region of an object 130 (e.g., when the object 130 is positioned at the object plane 126), as described elsewhere herein. FIG. 4B shows an example of an altered version of the pattern 404, which is carried by a reflected portion of the light (e.g., that is transmitted to the optical sensor 118), as described elsewhere herein.

As shown in FIG. 4A, the pattern 402 may be a grid pattern. For example, the pattern projection component 108 may include one or more pattern elements 202 that form a grid. Accordingly, because the one or more pattern elements 202 may cause (e.g., by interacting with the light) variations across a spatial distribution of the light in terms of brightness, intensity, shape, or other characteristics, the pattern 402 may be the grid pattern.

As shown in FIG. 4B, the altered version of the pattern 404 may be a grid pattern that includes one or more pattern alterations 406. For example, the pattern 404 may include a first type of pattern alteration 406-1 (e.g., a pattern shift alteration), a second type of pattern alteration 406-2 (e.g., a pattern omission alteration), a third type of pattern alteration 406-3 (e.g., a concave pattern distortion alteration), and/or a fourth type of pattern alteration 406-4 (e.g., a convex pattern distortion alteration), along with other examples. The one or more pattern alterations 406 may be associated with one or more surface irregularities associated with the region of the object 130 (e.g., due to dirt particles, dust particles, scratches, chips, fingerprints, debris, and/or other defects affecting a surface of the region of the object 130).

As indicated above, FIGS. 4A-4B are provided as one or more examples. Other examples may differ from what is described with regard to FIGS. 4A-4B. In practice, there may be additional components, fewer components, different components, or differently arranged components than those shown in FIG. 4A-4B.

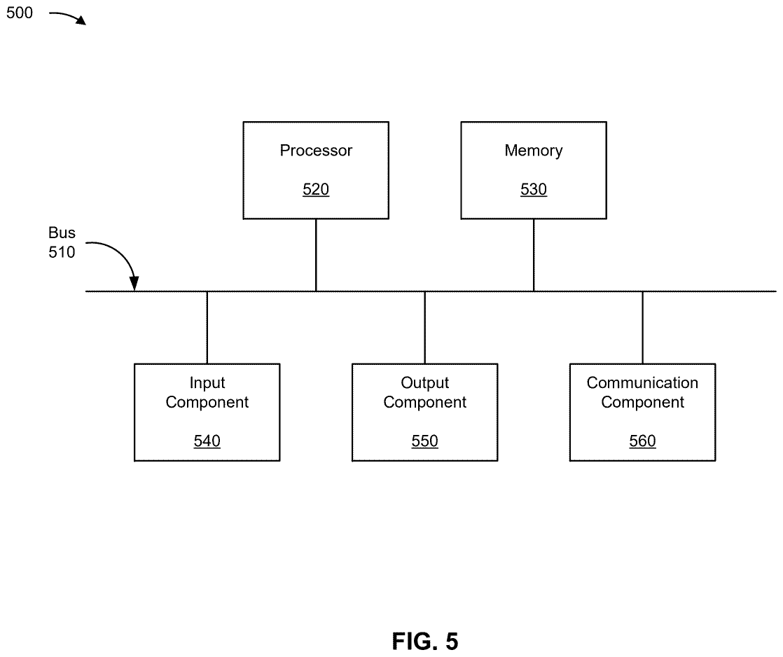

FIG. 5 is a diagram of example components of a device 500 associated with a microscope that includes a pattern projection component. The device 500 may correspond to the light source 104, the optical sensor 118, the one or more processors 302, and/or the display screen 304. In some implementations, the light source 104, the optical sensor 118, the one or more processors 302, and/or the display screen 304 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

The foregoing disclosure provides illustration and description, but is not intended to be exhaustive or to limit the implementations to the precise forms disclosed. Modifications and variations may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A microscope comprising:
a light source positioned at a light source plane of the microscope;
a pattern projection component positioned at a light stop plane of the microscope; and
an optical sensor positioned at an image plane of the microscope, wherein:
the light source is configured to transmit light to an object plane of the microscope via the pattern projection component, and
the pattern projection component is configured to, when the light interacts with the pattern projection component, cause the light to carry a pattern,
wherein the pattern, when the light transmits from the pattern projection component to an object positioned at the object plane, is projected on a region of the object.

2. The microscope of claim 1, wherein:
the pattern projection component includes one or more pattern elements that define the pattern.

3. The microscope of claim 2, wherein:
a pattern element, of the one or more pattern elements, comprises at least one of:
a reflective characteristic,
a diffractive characteristic,
a refractive characteristic,
an absorbent characteristic, or
a transmissive characteristic.

4. The microscope of claim 2, wherein:
the one or more pattern elements are embedded in a transmissive material.

5. The microscope of claim 1, wherein the microscope further comprises an aperture stop positioned at the light stop plane of the microscope, wherein:
the pattern projection component is disposed within the aperture stop.

6. The microscope of claim 5, wherein:
the pattern projection component is removably connected to the aperture stop.

7. The microscope of claim 1, wherein:
the microscope is an optical fiber inspection microscope;
the object is an optical fiber; and
the region of the object is an end face of the optical fiber.

8. The microscope of claim 1, wherein:
the optical sensor is configured to capture an image of the region of the object when the pattern is projected on the region of the object.

9. The microscope of claim 1, wherein the microscope further comprises one or more processors, wherein:
the one or more processors are configured to:
obtain, from the optical sensor, an image of the region of the object when the pattern is projected on the region of the object;
determine, based on the image, assessment information associated with the region of the object; and
provide the assessment information.

10. The microscope of claim 9, wherein the one or more processors, to provide the assessment information, are configured to:
send the assessment information to a display screen of the microscope to allow the display screen to display at least a portion of the assessment information.

11. A microscope comprising:
a light source; and
a pattern projection component positioned along a light path of light transmitted from the light source to an object plane of the microscope, wherein:
the pattern projection component is configured to cause the light to carry a pattern,
wherein the pattern, when the light transmits from the pattern projection component to an object positioned at the object plane, is projected on a region of the object.

12. The microscope of claim 11, wherein:
the pattern projection component includes one or more pattern elements that define the pattern.

13. The microscope of claim 12, wherein:
a pattern element, of the one or more pattern elements, comprises at least one of:
a reflective characteristic,
a diffractive characteristic,
a refractive characteristic,
an absorbent characteristic, or
a transmissive characteristic.

14. The microscope of claim 11, wherein the microscope further comprises an aperture stop, wherein:
the pattern projection component is removably connected to the aperture stop.

15. The microscope of claim 11, wherein the microscope further comprises one or more processors, wherein:
the one or more processors are configured to:
obtain, from an optical sensor of the microscope, an image of the region of the object with the pattern projected on the region of the object;
determine, based on the image, assessment information associated with the region of the object; and
provide the assessment information.

16. A pattern projection component for a microscope comprising:
one or more pattern elements that define a pattern,
wherein the one or more pattern elements are configured to cause light, that is transmitted from a light source of the microscope and to the pattern projection component, to carry the pattern when transmitted from the pattern projection component.

17. The pattern projection component of claim 16, wherein:
the one or more pattern elements are further configured to cause the pattern, when the light transmits from the pattern projection component to an object positioned at an object plane of the microscope, to be projected on a region of the object.

18. The pattern projection component of claim 16, wherein:
the pattern projection component is configured to be positioned between a light source plane of the microscope and an object plane of the microscope.

19. The microscope of claim 16, wherein:
the pattern projection component is configured to removably connect to an aperture stop of the microscope.

20. The microscope of claim 16, wherein:
the pattern projection component is configured to removably connect to the microscope.
